(19) United States
(12) Patent Application Publication
(10) Pub. No.: US 2026/0105297 A1
(43) Pub. Date: Apr. 16, 2026

(54) ENSEMBLE INSTRUCTION TUNING DATA GENERATION

(71) Applicant: International Business Machines Corporation, Armonk, NY (US)

(72) Inventors: Young-Suk Lee, Mahopac, NY (US); MD ARAFAT SULTAN, Croton-on-Hudson, NY (US); YOUSEF EL-KURDI, Mahopac, NY (US); TAHIRA NASEEM, Briarcliff Manor, NY (US); Asim Munawar, Demarest, NJ (US); Radu Florian, Danbury, CT (US); Salim Roukos, Redondo Beach, CA (US); Ramon Fernandez Astudillo, White Plains, NY (US)

(21) Appl. No.: 18/916,836

(22) Filed: Oct. 16, 2024

(51) Int. Cl. G06N 3/08; G06N 3/0475

(52) U.S. Cl. CPC G06N 3/08; G06N 3/0475

(57) ABSTRACT

Mechanisms are provided for generating instruction tuning training data to train a machine learning computer model. The mechanisms receive a set of seed tasks, each specifying an instruction tuning example having at least an instruction and an output. The mechanisms generate, by a first language model (LM), from instructions of seed tasks in a first portion of the set of seed tasks, a synthetically generated instruction. The mechanisms generate, by each second LM in a plurality of second LMs, based on the synthetically generated instruction and a second portion of the set of seed tasks, a predicted output. The mechanisms score the predicted outputs and select a highest scoring output based on the scoring of the predicted outputs. The mechanisms generate a synthetic instruction tuning example, for inclusion in a training dataset for training the machine learning computer model, based on the synthetic instruction and selected output.

The following disclosure(s) are submitted under 35 U.S.C. 102(b)(1)(A):
DISCLOSURE(S): “Ensemble-Instruct: Generating Instruction-Tuning Data with a Heterogeneous Mixture of LMs”, Young-Suk Lee, Md Arafat Sultan, Yousef El-Kurdi, Tahira Naseem, Asim Munawar, Radu Florian, Salim Roukos, Ramon Fernandez Astudillo, arXiv:2310.13961v1 [cs.CL], Oct. 21, 2023, 11 pages and in the Findings of the Association for Computational Linguistics: EMNLP 2023, pages 12561-12571, Dec. 6-10, 2023.

### BACKGROUND

The present application relates generally to an improved data processing apparatus and method and more specifically to an improved computing tool and improved computing tool operations/functionality for performing ensemble instruction tuning data generation.

Large Language Models (LLMs), also referred to as foundational models, require massive quantities of high quality training data to develop and fine-tune various generative models, such as ChatGPT, GPT-4, and IBM Granite models. One way of obtaining such large quantities of training data is via synthetic data generation which has proven effective for improving performance of generative language models. Various algorithms, simulations, and the like, may be used to generate such synthetic data.

In-Context Learning (ICL) is a technique used to train an LLM using a relatively small number of training examples. With ICL, the LLM is given a prompt as input and the LLM operates to perform a requested task specified in the prompt. The prompt includes a list of inputs and outputs that are associated with the task that the LLM is to perform. By processing the lists of inputs and outputs to perform the requested task, feedback may be provided to the LLM to indicate the error in the LLM operation to thereby fine-tune the LLM to a specific task.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method, in a data processing system, is provided for generating instruction tuning training data to train a machine learning computer model. The method comprises receiving, as input, a set of seed tasks, wherein each seed task specifies an instruction tuning example having at least an instruction and an output. The method also comprises generating, by at least one first language model (LM), from instructions of seed tasks in a first portion of the set of seed tasks, a synthetically generated instruction. In addition, the method comprises generating, by each second LM in a plurality of second LMs, based on the synthetically generated instruction and a second portion of the set of seed tasks, a predicted output. Furthermore, the method comprises scoring the predicted outputs from the plurality of second LMs, and selecting a highest scoring output based on the scoring of the predicted outputs. Moreover, the method comprises generating a synthetic instruction tuning example, for inclusion in a training dataset for training the machine learning computer model, based on the synthetic instruction and selected output.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system environment in which aspects of the illustrative embodiments may be implemented and at least some of the computer code involved in performing the inventive methods may be executed;

FIG. 2 is an example block diagram illustrating the primary operational components of an Ensemble-Instruct engine in accordance with one illustrative embodiment;

FIG. 3 is a diagram illustrating an overview of the operation of an Ensemble-Instruct engine in accordance with one illustrative embodiment;

FIG. 4A is a diagram illustrating an example of an output ensembling algorithm for open domain question answering in accordance with one illustrative embodiment;

FIG. 4B is a diagram illustrating an example of an output ensembling algorithm for content grounded question answering in accordance with one illustrative embodiment;

FIG. 5A is a diagram illustrating example in-context learning (ICL) templates for instance generation in accordance with one illustrative embodiment;

FIG. 5B is a diagram illustrating examples of instruction tuning datasets before and after output ensembling in accordance with one illustrative embodiment; and

FIG. 6 presents a flowchart outlining example operations of elements of the present invention with regard to one or more illustrative embodiments.

### DETAILED DESCRIPTION

The illustrative embodiments provide an improved computing tool and improved computing tool operations/functionality for performing ensemble instruction tuning data generation. The illustrative embodiments implement an in-context learning (ICL) specifically to generate synthetic data for training a machine learning computer model, such as a large language model (LLM) or the like. However, it has been determined that, while using ICL for data generation can train strong conversational agents with only a small amount of human annotated seed examples, such mechanisms require the use of very large language models (approximately 175 billion parameters) to generate the synthetic data, and these very large language models are available only through closed-access application programming interfaces (APIs) or have restricted model access so that they are not readily available to the general public. Moreover, most organizations and individuals do not have the resources to reasonably implement and train such very large language models.

The mechanisms of the illustrative embodiments operate to eliminate the reliance on very large language models to perform ICL based synthetic data generation and instead utilizes an ensemble technique involving an ensemble of relatively smaller language models (40 billion parameters or less). The illustrative embodiments provide a framework for ICL-based instruction tuning data generation, referred to herein as “Ensemble-Instruct”, which can be implemented for open domain and document-grounded task performance, e.g., question answering or the like. The ensemble-instruct mechanisms of the illustrative embodiments provide categorization and simplification of ICL prompts to ease the few-shot learning of the LLM, and further provides multiple smaller language models (LMs) with an ensemble of the outputs generated by these smaller LMs which selects the best scoring output as an example for inclusion in the training data for training an LLM. By using an ensemble of multiple LM outputs, the accuracy and diversity of the synthetically generated data is improved.

To select the best output from multiple outputs generated by a diverse set of LMs, in one or more illustrative embodiments, an automatic scoring metric, e.g., Rouge-L or the like, is used. In illustrative embodiments using the Rouge-L metric, this scoring metric computes agreements between two outputs on the basis of lexical matches. For each pair of outputs, the Rouge-L score is computed and the output that provides the largest agreement with the other outputs is selected. Selection of the output that maximally agrees with the other outputs of the LMs improves the output accuracy. Utilization of multiple LMs, as opposed to a single LM, diversifies the generated data.

With the Ensemble-Instruct mechanisms of the illustrative embodiments, the generation of synthetic training data or examples is performed using a relatively small human annotated seed tasks, e.g., approximately 175 human annotated seed tasks comprising instructions and instances of input/output or just output. The seed tasks are human annotated in-context learning (ICL) examples, where the ICL example comprises an instruction and an “instance” where the instruction may be the same across multiple seed tasks, but the “instance” is different. The “instance” comprises an optional input on which the action specified in the instruction is to be performed, and a non-optional output of the action. In some illustrative embodiments, the ICL example is a triplet input, where the triplet comprises an instruction, and input, and an output, and for ICL examples where the input is optionally not provided, the input may be set to a “don't care” value, e.g., zero or the like. In the annotated seed tasks, the instruction specifies the action to be performed, the input (if provided) specifies the content upon which the action is to be performed, and the output represents the correct output that the LM should generate if it properly processes the input, i.e., the human annotation of the seed task.

Two synthetic training data generation pipelines are provided to process the different types of seed tasks, i.e., those where the instance comprises the optional input and those that do not include an input. That is, the seed tasks are processed to categorize them into a first category of seed tasks requiring an instance having both input and output specifications in the prompt, and a second category of seed tasks requiring an instance with only an output specification in the prompt.

Seed tasks that match the first category are processed by the first pipeline and seed tasks matching the second category are processed by the second pipeline. Each pipeline processes the seed tasks to generate an instruction given the seed tasks, and to generate an instance given an instruction. The pipelines each implement an ensemble of different language models (LMs) and metrics, such as Rouge-L scoring or the like, to determine the best output from the LMs to select for inclusion in the synthetically generated training dataset. The LMs operate to first predict a new instruction based on a set of seed examples, predict an input, and then predict outputs based on the instruction and the predicted input. The selected best outputs, e.g., those having a highest score from the ensemble are added to the synthetic training dataset such that the first pipeline provides the best training examples in which the prompt requires an instance specifying both inputs and outputs, and the second pipeline provides the best training examples in which the prompt requires an instance having only the outputs specified. In some illustrative embodiments, a filtering threshold is utilized on all the outputs of the LMs of a given pipeline to ensure that all of the LMs are providing a sufficiently high score to represent a high quality synthetically generated training example.

Thus, given a set of annotated ICL examples comprising an instruction-input-output triplet, a set of language models, and engines implementing one or more ensemble-instruct pipelines, the illustrative embodiments output a set of new instruction tuning data comprising instruction-input-output triplets generated from the given language models. The new instruction tuning data sets may comprise tuples with new instructions, input (optional), and output which may be used alone, with the human annotated seed tasks, and/or other training data to provide training datasets for machine learning training of models. Thus, from a small set of seed examples, the mechanisms of the illustrative embodiments are able to generate additional high quality synthetic examples that can be added to the training dataset for training another machine learning computer model, e.g., a LLM or the like.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides an Ensemble-Instruct tool for generating instruction-tuning data with a heterogenous mixture of language models. The improved computing tool implements mechanism and functionality, such as an Ensemble-Instruct engine, which cannot be practically performed by human beings either outside of, or with the assistance of, a technical environment, such as a mental process or the like.

The improved computing tool provides a practical application of the methodology at least in that the improved computing tool is able to synthetically generate instruction-tuning data in a manner where smaller language models can generate data whose quality is as good as that generated by very large language models but avoids the issues associated with having to implement large language models (LLMs). As a result, the problems associated with accessibility of such synthetic data generation mechanisms are overcome with the mechanisms of the present invention, which utilizes relatively smaller language models (LMs) as opposed to the much larger LLMs.

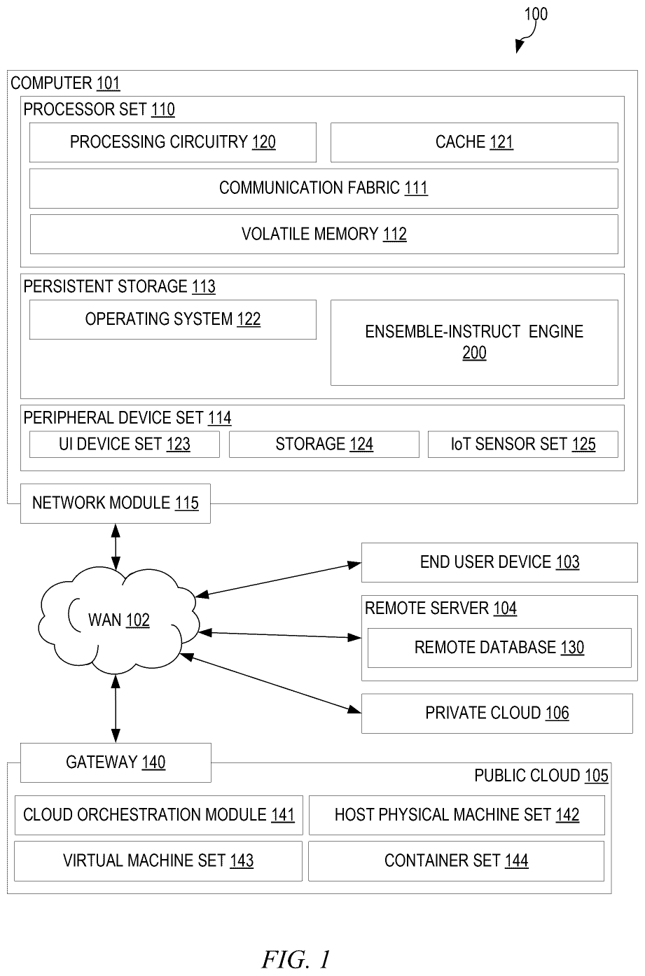

FIG. 1 is an example diagram of a distributed data processing system environment in which aspects of the illustrative embodiments may be implemented and at least some of the computer code involved in performing the inventive methods may be executed. That is, computing environment 100 contains an example of an environment for the execution of at least some of the computer code involved in performing the inventive methods, such as Ensemble-Instruct engine 200. In addition to Ensemble-Instruct engine 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and Ensemble-Instruct engine 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in Ensemble-Instruct engine 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in Ensemble-Instruct engine 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As shown in FIG. 1, one or more of the computing devices, e.g., computer 101 or remote server 104, may be specifically configured to implement an Ensemble-Instruct engine 200. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 101 or remote server 104, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates generation of instruction-tuning data using an ensemble of language models (LMs).

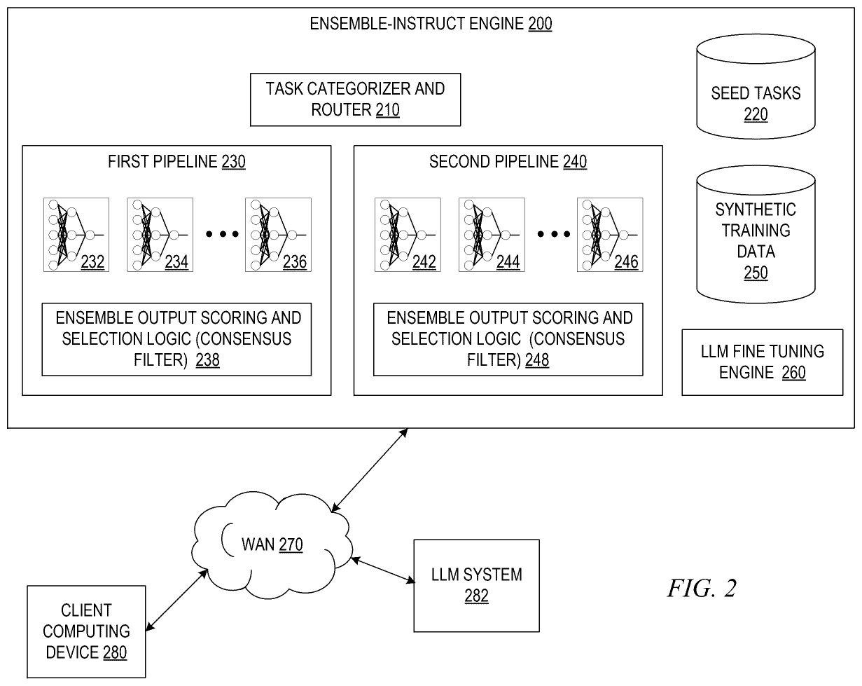

FIG. 2 is an example block diagram illustrating the primary operational components of an Ensemble-Instruct engine in accordance with one illustrative embodiment. The operational components shown in FIG. 2 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings and the resulting output may aid human beings. The invention is specifically directed to the automatically operating computer components directed to improving the way that synthetic instruction-tuning data is generated, and provides a specific solution that implements classifiers and pipelines with ensembles of language models, which cannot be practically performed by human beings as a mental process and is not directed to organizing any human activity.

As shown in FIG. 2, the Ensemble-Instruct engine 200 includes a task categorizer and router 210, a seed task storage 220, one or more pipelines 230 and 240, synthetic instruction tuning training data storage 250, and an LLM fine tuning engine 260. The Ensemble-Instruct engine 200 operates to generate synthetic instruction tuning training data 250 given the seed tasks 220 as input, where the seed tasks 220 are manually annotated instances of input ICL prompts for generating data from LLMs, for example. The seed tasks 220 are a relatively small set of annotated ICL prompts, e.g., approximately 175 ICL examples, from which a much larger set of synthetic training data is generated.

To further clarify the difference between ICL examples and synthetic training data, it should be appreciated that ICL examples are the input to the synthetic data generation pipeline, which enables the language models to learn the types of data they have to generate. The synthetic data may be also referred to as instruction tuning data, and is the output of the synthetic data generation pipeline. The synthetic data may be used by developers to fine-tune a language model. Both ICL examples and instruction tuning data may have the same format, which varies from LM to LM depending on the template used to train the LM. However, their functions are different. ICL examples (typically few in number) enables an LM to generate data. Instruction fine-tuning data (typically much larger than ICL examples in number) enables a developer to train an LM with this instruction fine-tuning data. ICL examples may be human generated by a system developer and/or users. Synthetic data, or instruction tuning data, is generated automatically through the mechanisms of the illustrative embodiments.

Returning to FIG. 2, the Ensemble-Instruct engine 200 generates the synthetic training data 250 using the one or more pipelines 230 and 240, each of which implements its own ensemble of machine learning computer models 232-236 and 242-246. These machine learning computer models 232-236 and 242-246 may be, for example, language models (LMs) which are considerably smaller than large language models (LLMs) as measured by the number of parameters evaluated as noted above. Each pipeline 230, 240 further comprises corresponding ensemble output scoring and selection logic 238, 248 which selects the highest quality outputs from the various machine learning computer models in the corresponding pipeline 230, 240.

In generating synthetic instruction tuning training data 250, the seed tasks 220 are input to the task categorizer and router 210 which, for each seed task, classifies the seed task with regard to a plurality of task categories. In the depicted example, there are two primary classes of seed tasks, i.e., those in which the tuple representing the ICL examples includes instruction-input-output, and those in which the tuple includes only instruction-output. It should be appreciated that this separation of the seed tasks 220 into classifications, in some embodiments may be eliminated, and is primarily used to facilitate improved operations of the machine learning computer models which operate with greater accuracy when presented with inputs that more closely resemble their training data. Thus, the machine learning computer models 232-236 are trained to operate on tuples in which the input is provided in the seed tasks 220, and the machine learning computer models 242-246 are trained to operate on tuples in which the input is not provided, or is a “don't care” value in the tuple. It should be appreciated that in some illustrative embodiments, a single pipeline may be utilized to process all seed tasks 220 and generate synthetic instruction tuning training data 250, or some pipelines in a multiple pipeline configuration may handle processing of more than one classification of seed tasks 220. Furthermore, there may be greater than two pipelines, with corresponding task classifications, without departing from the spirit and scope of the present invention.

Thus, the task categorizer and router 210 determines a classification of a given seed task 220 and then routes that seed task 220 to the corresponding pipeline 230, 240 for processing. In the depicted example, seed tasks 220 that require an input in order for the instruction to be meaningful (type A) are routed to the first pipeline 230, whereas seed tasks 220 that do not require an input in order for the instruction to be meaningful (type B) are routed to the second pipeline 240. In either case, however, the operation of the pipelines 230, 240 is essentially the same, but with different machine learning computer model ensembles being trained to process the particular corresponding type of seed tasks 220. Thus, the following description will describe an operation of the first pipeline 230, but it should be understood that the second pipeline 240 performs a similar operation.

In generating the synthetic instruction tuning training data, the process involves one or more of the machine learning computer models 232-236 of the first pipeline 230 to generate a new instruction from the seed task 220 that is input. The machine learning computer models 232-236 are a heterogeneous set of language models (LMs) that are trained to predict words or a string of characters given an input and a fixed size window of previous words or characters. Such LMs may be trained recurrent neural network-based computer models, for example, and are trained specifically to predict and generate natural language text given a natural language input. Due to the training, each LM may be trained differently such that their operational parameters may not match and thus, the LMs 232-236 are a heterogenous set of LMs. Moreover, as noted hereafter, the LMs 232-236 may be separated into sets or subsets whose operations are directed to performing different tasks, such as instruction generation, input generation, and output generation, for generating an instruction-tuning example (instruction-input-output). Thus, with the illustrative embodiments, given one or more seed tasks 220, one or more of these LMs 232-236 generate an instruction for the synthetic training data example.

In one illustrative embodiment, for type A seed tasks, a set of ICL demonstrations, e.g., 24 ICL demonstrations, are used during instruction generation, where the demonstration comprises examples of instructions that may be used in an ICL prompt. In the set of ICL demonstrations, a first portion of ICL demonstrations, e.g., 20, are randomly sampled from the seed tasks 220 having the same type, and a second portion, e.g., 4, are sampled from instructions previously generated by the LM, e.g., LM 232, itself. Thus, in generating the instruction, the LM uses not only the seed tasks 220, but previous instructions generated by the pipeline 230 such that the LMs 232-236 of the pipeline 230 may learn from their own prior instruction generation in a self-learning manner. As noted hereafter, the previous instructions generated by the pipeline 230 will be the highest scoring synthetic data generated by the ensemble of LMs and thus, represent high quality synthetic examples, or synthetic instruction tuning data, which in turn will improve the subsequent synthetic data generation due to the inputs being of higher quality.

In one illustrative embodiment, for type B seed tasks, the set of ICL demonstrations comprises a different set from that of the type A seed tasks, e.g., 10 ICL demonstrations, of which different portions come from the seed tasks of the same type and from previously generated synthetic instructions. For example, of the 10 ICL demonstrations, 8 may be sampled from the seed tasks 220 of the same type, and 2 are sampled from the previously generated synthetic instructions.

New instructions are added to the seed tasks 220 only if its Rouge-L score with every existing instruction is less than a predetermined threshold, e.g., 0.7 or the like. The Rouge-L score is one that evaluates the similarity between two given portions of text. In the present illustrative embodiments, pairings of synthetically generated examples generated by the ensemble of LMs 232-236 are evaluated using the Rouge-L score to thereby score them as to their similarity to each other. This score is then used, as described hereafter, to identify the best synthetically generated examples for inclusion in the synthetic training dataset 250. A similar approach can be performed with regard to the ICL instruction demonstrations. The threshold, e.g., 0.7, and the requirement that the Rouge-L score be below this threshold is intended to identify instructions that are not so significantly similar to other instructions that they will not provide an improvement in the diversity of the synthetic ICL training data 250.

Thus, a first set of one or more of the LMs 232-236 operates to generate a set of synthetic instruction tuning examples, using few-shot in-context learning. A second set of one or more LMs 232-236 operates to generate synthetic instances, where again the instances comprise an optional input and an output. In some illustrative embodiments, the same set of LMs 232-236 may be used to generate the instruction and the instances of the synthetic data, i.e., the first and second sets may be the same set of LMs. Each LM 232-236 in the second set may operate, given the synthetic instruction generated by the first set of one or more LMs 232-236, the instance comprising the input and output (or just the output in the case of the second pipeline 240). In addition, the second set of LMs 232-236 receives as input, randomly selected seed task 220 examples which may be used as evidence for generating the synthetic instances. It should be appreciated that the input portion of the instances will be consistent across each of the instances, although the outputs will most likely be different.

In one illustrative embodiment, during instance generation, the second set of LMs 232-236 uses a set of ICL demonstrations of type A tasks from the seed tasks 220, e.g., 18 ICL demonstrations. For type B tasks, a different set of ICL demonstrations of type B seed tasks 220 is utilized, e.g., 15 type B seed tasks.

In some illustrative embodiments, the instance generation may be separated into two operations, i.e., input generation and output generation. That is, a first sub-set of the second set of LMs may be used to generate the input portion of the instance. Similarly, a second sub-set of the second set of LMs may be used to generate the output portion of the instance given the synthetic instruction-input pair (type A) or the instruction (type B). The resulting instruction-tuning examples are the outputs of the LMs 232-236.

Thus, by synthetically generating the instruction and the instance portions of an instruction-tuning training example, the pipeline 230 has generated a plurality of synthetic instruction-tuning examples, e.g., the synthetic instruction paired with each instance generated by each of the LMs 232-236 in the second set of LMs. These synthetic instruction-tuning examples have a similar format to the seed tasks, e.g., a tuple of instruction-input-output. However, it is possible for the LMs to generate inaccurate synthetic instruction-tuning examples. In order to address this possibility of inaccurate synthetic instruction-tuning examples, the ensemble output scoring and selection logic 238, 248 is provided, which may also be referred to herein as a consensus filter 238, 248. Instead of simply accepting the synthetically generated instruction-tuning examples, the consensus filters 238, 248 score the instruction-tuning examples, and select high quality data for inclusion in the instruction tuning training data 250. What drives the synthetic data generation pipeline 230 is ICL examples, which are relatively very few in number. The output of the pipeline 230 is the instruction tuning examples, which are relatively large in number. Again, while the format of ICL examples and instruction tuning examples may be the same, the usage is different. In addition, a small number of ICL examples are typically hand-crafted by expert humans, whereas the instruction tuning data sets from the pipeline 230 are completely machine generated.

In some illustrative embodiments, the scoring may comprise the generation of a Rouge-L score between all the pairings of the outputs from the LMs 232-236. Rouge-L scoring is generally known in the art and thus, a more detailed explanation is not provided herein. These illustrative embodiments specifically apply Rouge-L to the pairings of synthetically generated outputs, which quantifies the similarity of the outputs in each pairing. It should be appreciated that Rouge-L scoring is only one possible metric for evaluating the synthetically generated instruction tuning examples, i.e., the tuples instruction-input-output, and other metrics may also, or alternatively, be utilized depending on the desired implementation. Any metrics that are able to identify the more accurately generated outputs may be used without departing from the spirit and scope of the present invention.

Moreover, the consensus filter 238, 248 applies one or more thresholds to identify the minimum requirements for inclusion as an instruction-tuning example in the synthetic training data 250. For example, a threshold may be set to indicate a minimum Rouge-L score required for each of the synthetically generated outputs for inclusion in the synthetic training data 250. This is to ensure that all of the synthetic examples generated by the LMs 232-236 are sufficiently accurate as to serve as valuable LM training data. Essentially, if the lowest Rouge-L score of the output is above this threshold, the first element of the pair with the highest Rouge-L score is selected by the consensus filter 238, 248. If this selection results in none of the outputs being selected because the threshold is not met, then the generated synthetic examples are effectively filtered out.

The selected synthetically generated output, along with its instruction and input, is then added to the synthetic training data 250. The synthetic training data 250 may be used by the LLM fine tuning engine 260 to fine tune an LLM system 282, via one or more data networks 270, such that the LLM system 282 may perform more accurate operations with regard to requests from client computing devices, such as client computing device 280. The synthetic training data 250 comprises a diverse and accurate set of instruction tuning examples due to the ensemble generation of such examples and the thresholding and filtering implemented to ensure high quality synthetic output generation given synthetic instructions and input. Since the quality of the training data 250 is improved through the operations of the illustrative embodiments, the subsequent fine-tuned training of the LLM is also improved, as machine learning training is highly dependent upon the quality of the training data. Moreover, because the invention can generate large quantities of synthetic training data from only a small set of manually annotated seed examples, the invention can generate sufficient size datasets for fine-tuning an LLM, which again improves the performance of the LLM since the quality of an LLM is also dependent on the amount of training data utilized during its training.

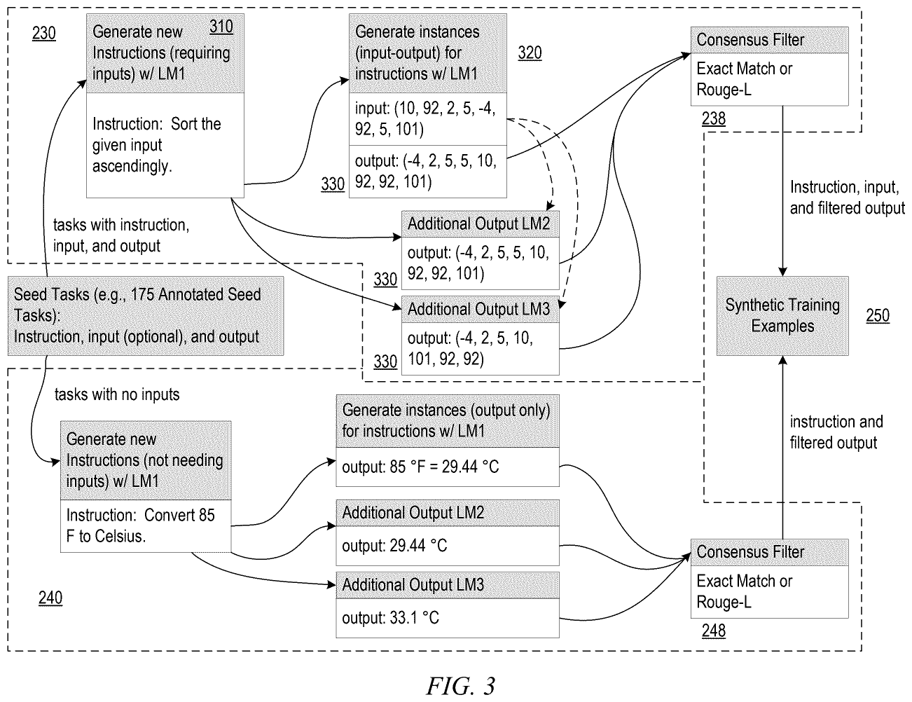

FIG. 3 is a diagram illustrating an overview of the operation of an Ensemble-Instruct engine in accordance with one illustrative embodiment. The example shown in FIG. 3 is not intended to be limiting on the illustrative embodiments or the present invention and is offered as an example of the flow of the pipelines 230, 240 in FIG. 2 in accordance with one example illustrative embodiment. As shown in FIG. 3, in this example, 175 human annotated seed tasks, comprising the tuple instruction-input-output are utilized, where the “input” is optional such that some seed tasks will have the input specified and others will not, or will have a “don't care” value for the input. The top portion of the figure shows a pipeline for seed tasks with instruction, input, and output specified, i.e., pipeline 230 in FIG. 2. The bottom portion of the figure shows a pipeline for seed tasks where the input is not specified or is a “don't care” value, i.e., pipeline 240 in FIG. 2.

As shown in FIG. 3, given a set of human annotated seed tasks with instruction-input-output, the pipeline 230 using one or more language models, e.g., LM1, to generate a synthetic instruction 310, e.g., “Sort the given input ascendingly”. The same LM, e.g., LM1, or one or more different LMs, may use the synthetically generated instruction 310 to generate synthetic input data 320 and synthetic output 330. Moreover, additional outputs, given the same input data 320, may be generated by one or more additional LMs, e.g., LM2 and LM3 in the depicted example. This will generate a plurality of outputs having the synthetically generated instruction 310 and the synthetically generated input 320, which will be consistent across the plurality of outputs 330 generated by the different LMs, e.g., LM1, LM2, and LM3 in this example.

The consensus filter 238 will then score and select either none of the synthetically generated outputs, or one of the plurality of outputs having the best score of an evaluation metric for selection. For example, the consensus filter 238 may generate the Rouge-L score for each pairing of the outputs and ensure that all of the pairings have greater than a predetermined threshold score. If this criterion is met, then the first element of the pairing for the highest Rouge-L scoring pair is selected for inclusion in the synthetic training examples 250. A similar process is performed by the pipeline 240 but with regard to examples that do not need the input specified. In such a case, input generation is not required as part of the pipeline 240 operations and only the instruction and outputs are synthetically generated, as shown in FIG. 3.

It should be appreciated that the mechanisms of the illustrative embodiments may be implemented for open domain embodiments and for content ground embodiments. Open domain indicates that the synthetic data is not restricted to any specific domain or text. The data can be about any topic and/or subject and does not rely on any provided document. On the other hand, content grounded synthetic data indicates that the generated synthetic data should be grounded on the provided content, e.g., a text document.

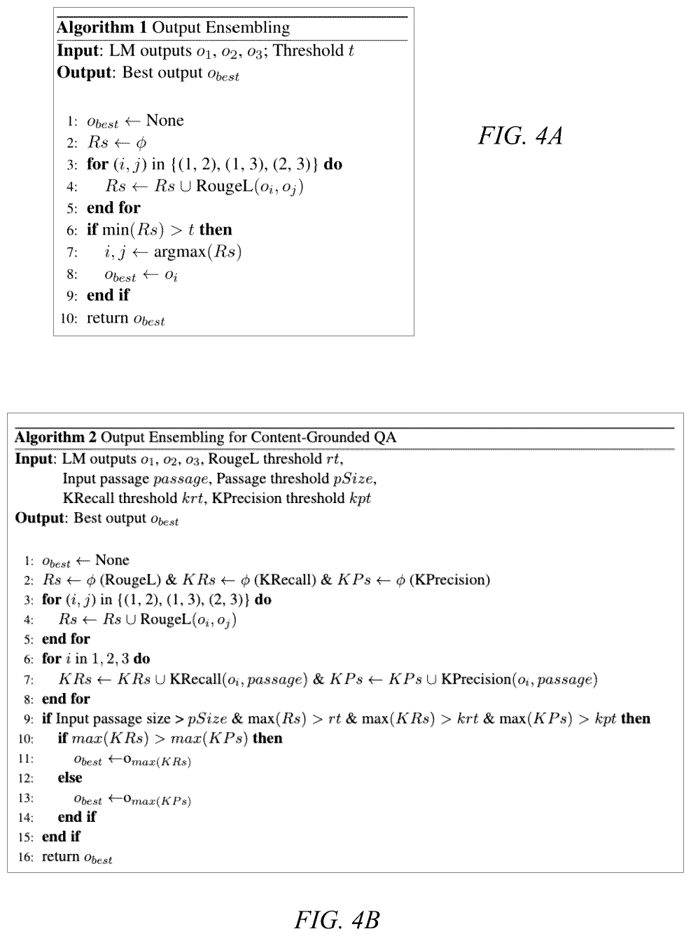

FIG. 4A is a diagram illustrating an example of an output ensembling algorithm for open domain embodiments in accordance with one illustrative embodiment. The algorithm of FIG. 4A may be executed in the consensus filters to select the best output along with its instruction and input for inclusion in the synthetic training examples.

With the algorithm of FIG. 4A, given multiple synthetically generated outputs O1, O2, O3, for the same instruction and input, and the pre-defined Rouge-L metric threshold t, the algorithm generates the best output O_{best}. For each pair of the outputs (O1, O2), (O1, O3), and (O2, O3), the Rouge-L scores (Rs) are generated. It should be noted that this example algorithm is only looking at the synthetically generated outputs as the same instruction and inputs are used to generate multiple outputs by multiple LMs. If the Rouge-L score for the lowest scoring pair is greater than the pre-specified threshold t, then the output pair with the highest Rouge-L score is selected and the best output, O_{best}, is the first output of the output pair with the highest Rouge-L score. The selected output, O_{best}, is then returned for inclusion in the synthetic training dataset.

FIG. 4B is a diagram illustrating an example of an output ensembling algorithm for content grounded question answering in accordance with one illustrative embodiment. Again, the algorithm in FIG. 4B may be executed in the consensus filters to select a synthetic example for inclusion in the synthetic training data. The content-grounded algorithm requires some additional parameters and metrics to implement the algorithm but maintains the overall data generation pipelines of the Ensemble-Instruct engine 200 for instance generation with input and output. The additional parameters for output ensembling include an input passage (or document) with the synthetically generated query-answer (this example is for question answering (QA) by LLMs). It should be appreciated that while the depicted example is for QA by LLMs, the illustrative embodiments are not limited to such. Rather, the illustrative embodiments are applicable to any input, not just questions (e.g., imperatives), and outputs.

The additional parameters further include a passage threshold (pSize) which specifies a minimum length of the passage, where the passage, or document, is any portion of natural language content that has at least the minimum length size (pSize). The additional parameters further include a knowledge recall (KRecall) and knowledge precision (KPrecision) parameter. The KRecall parameter determines the recall of the generated answer with respect to the input passage and the KPrecision parameter is the precision of the generated answer with respect to the input passage. The KRecall and KPrecision parameters measure the degree to which the generated response is faithful to the given passage. The algorithm determines if KRecall is greater than a pre-specified KRecall threshold (krt) and if a KPrecision is greater than a pre-specified KPrecision threshold (kpt). A preference is given to KRecall over KPrecision for the final output selection.

That is, in this example algorithm, a set of multiple outputs, generated from multiple LMs, are received as input, along with an input document, and the best output is selected according to the algorithm which performs the following operations. The algorithm computes pairwise Rouge-L scores across all output pairs. The algorithm computes Knowledge-Recall between each output and the given document. The algorithm computes Knowledge-Precision between each output and the given document. If each of the input document size, max(Rouge-L), max(Knowledge-Recall), and max(Knowledge-Precisions) are greater than pre-specified thresholds, and if max(Knowledge-Recall)>max(Knowledge-Precision), then the output with the higher Knowledge-Recall is as the best output. If these conditions are not met, the output with the highest Knowledge-Precision is as the best output.

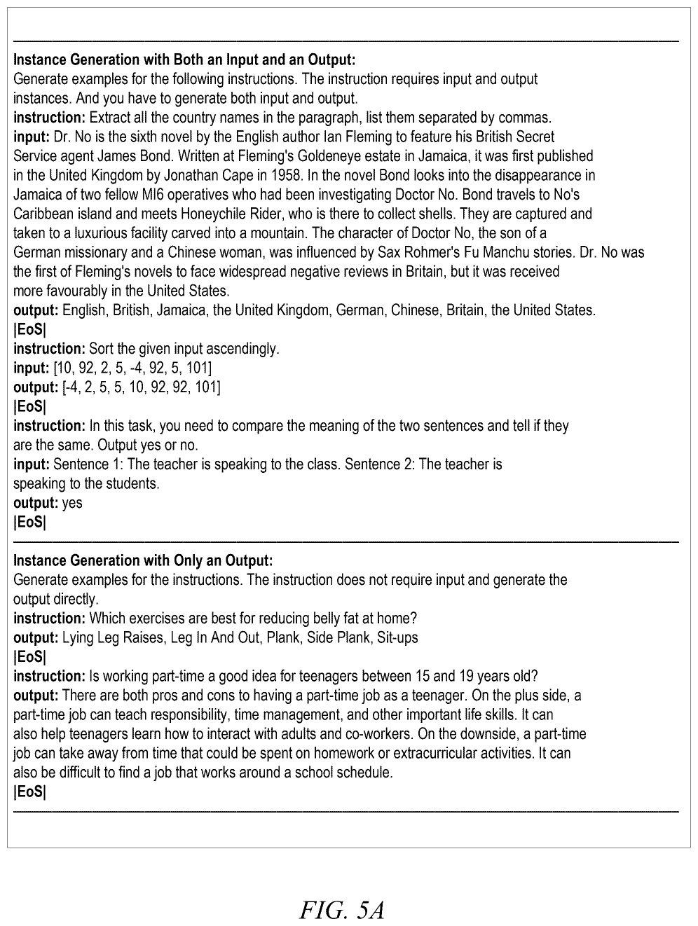

FIG. 5A is a diagram illustrating example in-context learning (ICL) templates for instance generation in accordance with one illustrative embodiment. As shown in these examples, the ICL templates include a tuple of instruction-input-output. For example, the first example ICL template includes an instruction of “Extract all the country names in the paragraph, list them separated by commas.” The input is the paragraph upon which the action specified in the instruction is to be performed. The output specifies the correct outputs for the action being performed on the given paragraph, e.g., in the first example, it is each of the countries mentioned in the input, separated by commas. For the second example, the output is the numerical values of the input arranged in ascending order. These examples can be used as input to the LMs to first generate a new instruction based on the instructions in the examples, and then process the input given the new instruction to generate a predicted output. The predicted output will then be evaluated using the Rouge-L metric between the various outputs generated by the ensemble of LMs and a best example having the instruction, input, and the best output will be selected for inclusion in the synthetic training dataset.

FIG. 5B is a diagram illustrating examples of instruction tuning datasets before and after output ensembling in accordance with one illustrative embodiment. In FIG. 5B, the “output-before” indicates the outputs of the various LMs prior to ensembling through the use of the Rouge-L metric scoring and selection of the best output by the consensus filter. After executing the consensus filtering, the “output-after” is generated. As can be seen in each of these examples, the “output-after” provides an accurate output of the application of the instruction to the input, e.g., the value “50” is the maximum number from the set of numbers, the statement “the product has a rounded body shape” accurately reflects the action in the instruction to describe a specific feature of a product specified in the input, etc. Thus, where some of the outputs before ensembling are not accurate, through the ensembling and consensus filter, a more accurate output may be selected for use, having the given instruction and input.

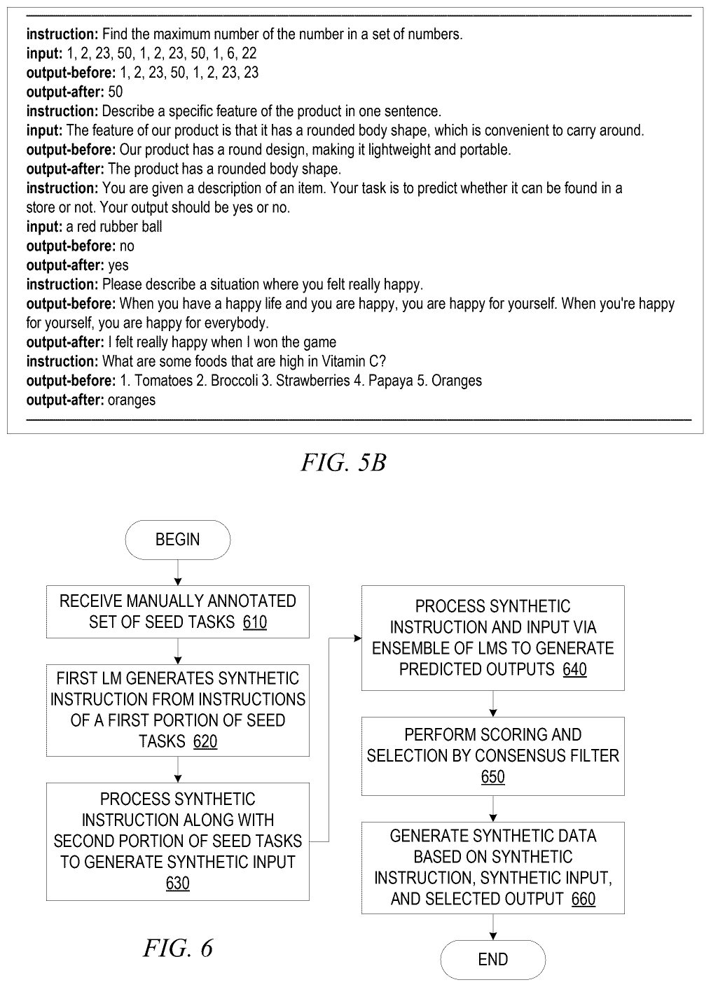

FIG. 6 presents a flowchart outlining example operations of elements of the present invention with regard to one or more illustrative embodiments. It should be appreciated that the operations outlined in FIG. 6 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIG. 6, and may, in some cases, make use of the results generated as a consequence of the operations set forth in FIG. 6, the operations in FIG. 6 themselves are specifically performed by the improved computing tool in an automated manner.

As shown in FIG. 6, the operation starts by receiving a set of seed tasks that have been manually annotated with correct outputs (step 610). The instructions of a first portion of the seed tasks are processed by a first LM to generate a new synthetically generated instruction (step 620). The new synthetically generated instruction is then processed, along with a second portion of the seed tasks, by the first LM, or another LM, to generate a synthetic input (step 630). The synthetically generated instruction and input are then processed by an ensemble of LMs to generate, for each LM, an output representing what the LM believes to be the correct output for the given requested action in the synthetic instruction being executed with regard to the synthetic input (step 640). The outputs are input to a consensus filter which scores the outputs, e.g., Rouge-L scores between pairings of outputs, and selects a best output based on the scores and a filtering criteria, e.g., all Rouge-L scores being above a threshold, and a first element of a pairing having the highest Rouge-L score being selected (step 650). The synthetic instruction, synthetic input, and best output are combined to generate a training example for inclusion in the training dataset (step 660). The operation then terminates.

It should be appreciated that while FIG. 6 terminates, further operations for training an LLM using the synthetically generated instruction tuning data may also be included to thereby fine-tune the LLM. Moreover, the process may be performed with regard to different pipelines and different classifications of the seed tasks' ICL prompts, e.g., those that require inputs to be specified and those that do not. Thus, the operation in FIG. 6 may be optionally modified to include operations to classify the seed tasks and route them to the appropriate pipeline for processing in the manner outlined in FIG. 6. Moreover, the operations in a pipeline processing seed tasks for which the input is not a requirement for a meaningful ICL prompt, the prediction of an input from the synthetic instruction need not be included.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system, for generating instruction tuning training data to train a machine learning computer model, the method comprising:
receiving, as input, a set of seed tasks, wherein each seed task specifies an instruction tuning example having at least an instruction and an output;
generating, by at least one first language model (LM), from instructions of seed tasks in a first portion of the set of seed tasks, a synthetically generated instruction;
generating, by each second LM in a plurality of second LMs, based on the synthetically generated instruction and a second portion of the set of seed tasks, a predicted output;
scoring the predicted outputs from the plurality of second LMs;
selecting a highest scoring output based on the scoring of the predicted outputs; and
generating a synthetic instruction tuning example, for inclusion in a training dataset for training the machine learning computer model, based on the synthetic instruction and selected output.

2. The method of claim 1, wherein the scoring comprises generating a Rouge-L score for each pairing of outputs from the plurality of second LMs.

3. The method of claim 2, wherein selecting a highest scoring output comprises selecting a pairing of outputs having a relatively highest Rouge-L score, and selecting a first element of the selected pairing as the selected output.

4. The method of claim 2, wherein selecting a highest scoring output further comprises comparing a lowest Rouge-L score to a predetermined threshold to determine if the lowest Rouge-L score is equal to or above the predetermined threshold, wherein the selection of the highest scoring output is performed in response to the lowest Rouge-L score being equal to or above the predetermined threshold, and wherein if the lowest Rouge-L score is below the predetermined threshold, all of the outputs of the ensemble of second LMs are filtered out.

5. The method of claim 1, wherein the data processing system comprises a plurality of different pipelines for different types of seed tasks, wherein each pipeline comprises a corresponding first LM, of the at least one first LMs, and a corresponding set of second LMs from the plurality of second LMs, and wherein the method comprises performing the generating of the synthetic instruction, generating the predicted output, and scoring the predicted outputs separately in each of the different pipelines.

6. The method of claim 5, further comprising routing each seed task, in the set of seed tasks, to a corresponding pipeline, in the plurality of different pipelines based on a corresponding type of the seed task, wherein the corresponding type is one of a first type of seed task that requires an input to be specified, or a second type of seed task that does not require an input to be specified.

7. The method of claim 1, wherein the seed tasks in the set of seed tasks comprise annotated in-context learning (ICL) examples for training a language model.

8. The method of claim 7, wherein the seed tasks in the set of seed tasks comprise annotated ICL examples specifying an instruction-query-response triplet, the plurality of second LMs are content-grounded question answering LMs, and the synthetic instruction tuning example comprises a query and corresponding response.

9. The method of claim 1, wherein scoring the predicted outputs from the plurality of second LMs further comprises:
receiving as input, the plurality of outputs from the plurality of second LMs and an input document;
computing pairwise Rouge-L scores across all output pairs in the plurality of outputs;
computing a Knowledge-Recall score between each output, in the plurality of outputs, and the input document; and
computing Knowledge-Precision scores between each output, in the plurality of outputs, and the input document, and wherein selecting the highest scoring output based on the scoring of the predicted outputs further comprises:
executing a first determination, for each of a size of the input document, a maximum computed Rouge-L score, a maximum computed Knowledge-Recall score, and a maximum Knowledge-Precisions score, as to whether corresponding predetermined thresholds are met, to thereby generate first determination results;
executing a second determination of whether the maximum computed Knowledge-Recall score is greater than a maximum computed Knowledge-Precision score, to thereby generate second determination results;
in response to the first determination results and second determination results being positive, selecting an output with a maximum Knowledge-Recall score as the highest scoring output; and
in response to at least one of the first determination results and second determination results being negative, selecting an output with a maximum Knowledge-Precision score as the highest scoring output.

10. The method of claim 1, wherein the machine learning computer model is a large language model (LLM), and wherein the at least one first LM and plurality of second LMs are LMs that are smaller than the LLM.

11. A computer program product comprising a computer readable storage medium having a computer readable program stored therein, wherein the computer readable program, when executed in a data processing system, causes the data processing system to:
receive, as input, a set of seed tasks, wherein each seed task specifies an instruction tuning example having at least an instruction and an output;
generate, by at least one first language model (LM), from instructions of seed tasks in a first portion of the set of seed tasks, a synthetically generated instruction;
generate, by each second LM in a plurality of second LMs, based on the synthetically generated instruction and a second portion of the set of seed tasks, a predicted output;
score the predicted outputs from the plurality of second LMs;
select a highest scoring output based on the scoring of the predicted outputs; and
generate a synthetic instruction tuning example, for inclusion in a training dataset for training a machine learning computer model, based on the synthetic instruction and selected output.

12. The computer program product of claim 11, wherein the scoring comprises generating a Rouge-L score for each pairing of outputs from the plurality of second LMs.

13. The computer program product of claim 12, wherein selecting a highest scoring output comprises selecting a pairing of outputs having a relatively highest Rouge-L score, and selecting a first element of the selected pairing as the selected output.

14. The computer program product of claim 12, wherein selecting a highest scoring output further comprises comparing a lowest Rouge-L score to a predetermined threshold to determine if the lowest Rouge-L score is equal to or above the predetermined threshold, wherein the selection of the highest scoring output is performed in response to the lowest Rouge-L score being equal to or above the predetermined threshold, and wherein if the lowest Rouge-L score is below the predetermined threshold, all of the outputs of the ensemble of second LMs are filtered out.

15. The computer program product of claim 11, wherein the data processing system comprises a plurality of different pipelines for different types of seed tasks, wherein each pipeline comprises a corresponding first LM, of the at least one first LMs, and a corresponding set of second LMs from the plurality of second LMs, and wherein the method comprises performing the generating of the synthetic instruction, generating the predicted output, and scoring the predicted outputs separately in each of the different pipelines.

16. The computer program product of claim 15, wherein the computer readable program further causes the data processing system to route each seed task, in the set of seed tasks, to a corresponding pipeline, in the plurality of different pipelines based on a corresponding type of the seed task, wherein the corresponding type is one of a first type of seed task that requires an input to be specified, or a second type of seed task that does not require an input to be specified.

17. The computer program product of claim 11, wherein the seed tasks in the set of seed tasks comprise annotated in-context learning (ICL) examples for training a language model.

18. The computer program product of claim 17, wherein the seed tasks in the set of seed tasks comprise annotated ICL examples specifying an instruction-query-response triplet, the plurality of second LMs are content-grounded question answering LMs, and the synthetic instruction tuning example comprises a query and corresponding response.

19. The computer program product of claim 11, wherein scoring the predicted outputs from the plurality of second LMs further comprises:
receiving as input, the plurality of outputs from the plurality of second LMs and an input document;
computing pairwise Rouge-L scores across all output pairs in the plurality of outputs;
computing a Knowledge-Recall score between each output, in the plurality of outputs, and the input document; and
computing Knowledge-Precision scores between each output, in the plurality of outputs, and the input document, and wherein selecting the highest scoring output based on the scoring of the predicted outputs further comprises:
executing a first determination, for each of a size of the input document, a maximum computed Rouge-L score, a maximum computed Knowledge-Recall score, and a maximum Knowledge-Precisions score, as to whether corresponding predetermined thresholds are met, to thereby generate first determination results;
executing a second determination of whether the maximum computed Knowledge-Recall score is greater than a maximum computed Knowledge-Precision score, to thereby generate second determination results;
in response to the first determination results and second determination results being positive, selecting an output with a maximum Knowledge-Recall score as the highest scoring output; and
in response to at least one of the first determination results and second determination results being negative, selecting an output with a maximum Knowledge-Precision score as the highest scoring output.

20. An apparatus comprising:
at least one processor; and
at least one memory coupled to the at least one processor, wherein the at least one memory comprises instructions which, when executed by the at least one processor, cause the at least one processor to:
receive, as input, a set of seed tasks, wherein each seed task specifies an instruction tuning example having at least an instruction and an output;
generate, by at least one first language model (LM), from instructions of seed tasks in a first portion of the set of seed tasks, a synthetically generated instruction;
generate, by each second LM in a plurality of second LMs, based on the synthetically generated instruction and a second portion of the set of seed tasks, a predicted output;
score the predicted outputs from the plurality of second LMs;
select a highest scoring output based on the scoring of the predicted outputs; and
generate a synthetic instruction tuning example, for inclusion in a training dataset for training a machine learning computer model, based on the synthetic instruction and selected output.
